(19) United States
(12) Patent Application Publication
(10) Pub. No.: US 2025/0388375 A1
(43) Pub. Date: Dec. 25, 2025

(54) CAP AND CONTAINER HAVING CAP

(71) Applicant: Xiamen CHUFUNYU Co., Ltd., Xiamen (CN)

(72) Inventors: Kuan-Yu Lin, Xiamen (CN); Heng-Yu Lin, Xiamen (CN)

(21) Appl. No.: 19/241,476

(22) Filed: Jun. 18, 2025

(30) Foreign Application Priority Data
Jun. 24, 2024 (CN) 202410821911.4

(51) Int. Cl. B65D 51/18; B65D 53/02

(52) U.S. Cl. CPC B65D 51/18; B65D 53/02; B65D 2251/0012; B65D 2251/0078

(57) ABSTRACT

A cap and a container are provided. The cap includes a body and a rotary plug element. The rotary plug element is threadedly coupled in the body. The rotary plug element is provided with first threaded protrusions. The first threaded protrusions are each provided with a first snap fit structure. The body is provided with second threaded protrusions and second snap fit structures. The first snap fit structure and the second snap fit structure form a snap fit. The first snap fit structure is arranged at the first threaded protrusion.

### CROSS-REFERENCE TO RELATED APPLICATIONS

This application claims priority to Chinese Patent Application 202410821911.4, filed on Jun. 24, 2024, which is incorporated herein by reference.

### TECHNICAL FIELD

The invention relates to the technical field of containers, and in particular to a cap and a container having the cap.

### BACKGROUND

Many containers used in daily life are equipped with caps configured to prevent dust or seal the containers. The existing caps in the market are basically separable from the containers. Especially for a container containing a liquid, it is required to remove the cap before the liquid is poured, which is inconvenient to operate. U.S. Pat. No. 11,034,505B2 discloses a container and a method of forming a container. A cap of the container includes an opening adapter and a plug structure arranged in the opening adapter. The plug structure and the opening adapter form a threaded coupling. A lower end of the plug structure is provided with retention tabs. The opening adapter is fixedly arranged at the opening. When the cap is in a closed state, the plug structure and the opening adapter form a sealed coupling, and the retention tabs of the plug structure extend to below the opening adapter. When the liquid in the container needs to be poured, the plug structure is rotated to make the plug structure move upward in the opening adapter so as to open a top of the opening adapter. At this time, the retention tabs of the plug structure move upward until they abut against the opening adapter, and the plug structure is limited from continuing moving upward under the abutting action, so that the plug structure and the opening adapter are retained in the coupled state. When pouring the liquid, there is no need to remove the cap, thereby preventing the cap from being lost. Moreover, simply by rotating the plug structure by a small amount, the liquid can flow out, which is convenient to operate.

However, firstly, the arrangement of the retention tabs at the lower end of the plug structure increases the overall height of the plug structure, which increases the overall height of the container in the case of the same container volume and makes the container less convenient to carry. Secondly, a lid separately arranged on the opening adapter further increases the height of the container. Finally, the retention tabs are suspended at the lower end of the plug structure. In order to ensure the size of a top opening of the opening adapter and the convenience of mounting the plug structure, the retention tabs must be set to be longer, which leads to a reduction in the strength of the retention tabs, such that the retention tabs are easily deformed or even broken, thereby reducing the service life of the cap.

### SUMMARY

An objective of the invention is to provide a cap with no need for removal and a smaller height and a container having the cap, so as to solve the problem of an excessive height in the existing cap.

In order to achieve the above objective, one technical solution of the invention includes: A cap includes a body and a rotary plug element. The rotary plug element is arranged in the body and forms a threaded coupling with the body. The rotary plug element is selectively located in a first position or a second position of the body through the threaded coupling. When the rotary plug element is located in the first position of the body, a ring-shaped channel is formed between the rotary plug element and the body. When the rotary plug element is located in the second position of the body, the rotary plug element forms a sealed coupling with the body. The first position of the body relative to the second position is defined as an open direction and an opposite as a closed direction. The rotary plug element includes a rotary plug portion provided with first threaded protrusions. The first threaded protrusions are each provided with a first snap fit structure protruding along a radial direction of the rotary plug portion. The body is provided with second threaded protrusions and second snap fit structures that extend along a radial direction of the body. The second snap fit structure is located in the closed direction of the second threaded protrusion. When the rotary plug element is located in the first position or the second position of the body, the first snap fit structure and the second snap fit structure form a snap fit.

Another technical solution of the invention includes: A container includes an open container and the above-mentioned cap. A body of the cap is coupled to the open container so as to couple the cap to the open container.

The invention has the following beneficial effects:
1. The closing and pouring of liquid of the cap are realized through the threaded coupling between the rotary plug element and the body, and the snap fit between the rotary plug element and the body is realized through the first snap fit structures and the second snap fit structures. Thereby, the rotary plug element can be switched between the first position and the second position relative to the body, and there is no need to remove the rotary plug element for pouring of liquid, which is more convenient to operate and can prevent the cap from being lost when used on the open container.
2. The first snap fit structure is arranged at the first threaded protrusion, which can reduce the axial length of the rotary plug element, thereby reducing the overall height of the cap and the height of the container having the cap. This makes the container more reasonable in structure and more convenient to carry.
3. The two first snap fit structures and the two second snap fit structures are oppositely arranged along any diameter of the rotary plug portion or the body. Thereby, when the rotary plug element is rotated by 180°, the first snap fit structure is switched from forming a snap fit with one second snap fit structure to forming a snap fit with the other second snap fit structure. That is, when the rotary plug element is rotated by 180°, it moves from the first position to the second position so as to open the channel of the cap. There is no need to rotate the rotary plug element too many turns, which is simple and convenient to operate and saves both time and labor. The body may also be provided with indications for open and closed states to provide visual feedback to the user, so that the user can determine whether the cap is in the open or closed state simply by visual observation, thereby avoiding misoperation. Moreover, tactile feedback can be given to the user at the moment when the first snap fit structure snaps into the second snap fit structure.
4. When pouring the contents of the container, the ring-shaped discharge portion arranged functions to guide the contents, thereby preventing the poured contents from scattering around.

### BRIEF DESCRIPTION OF DRAWINGS

FIG. 1 is a three-dimensional view of Embodiment 1 of the invention;

FIG. 2 is a top view of Embodiment 1 of the invention;

FIG. 3 is an exploded view of Embodiment 1 of the invention;

FIG. 4 is a bottom view of a rotary plug element of Embodiment 1 of the invention;

FIG. 5 is a top view of a body of Embodiment 1 of the invention;

FIG. 6 is a sectional view of the rotary plug element of Embodiment 1 of the invention in a second position P₂ taken along line A-A;

FIG. 7 is a sectional view of FIG. 6 taken along line D-D;

FIG. 8 is a partial enlarged view of C in FIG. 6;

FIG. 9 is a sectional view of the rotary plug element of Embodiment 1 of the invention in a first position P₁ taken along line A-A;

FIG. 10 is a sectional view of the rotary plug element of Embodiment 1 of the invention in the first position P₁ taken along line B-B; and

FIG. 11 is a three-dimensional view of Embodiment 2 of the invention.

### DESCRIPTION OF EMBODIMENTS

To further illustrate the embodiments, the accompanying drawings are provided in the invention. These accompanying drawings are a part of the contents disclosed in the invention that are mainly used to illustrate the embodiments, and can be used in conjunction with the related descriptions in the specification to explain the operation principle of the embodiments. With reference to these contents, those of ordinary skill in the art should be able to understand other possible implementations and advantages of the invention. Components in the drawings are not drawn to scale, and like component symbols are usually used to represent like components.

### Embodiment 1

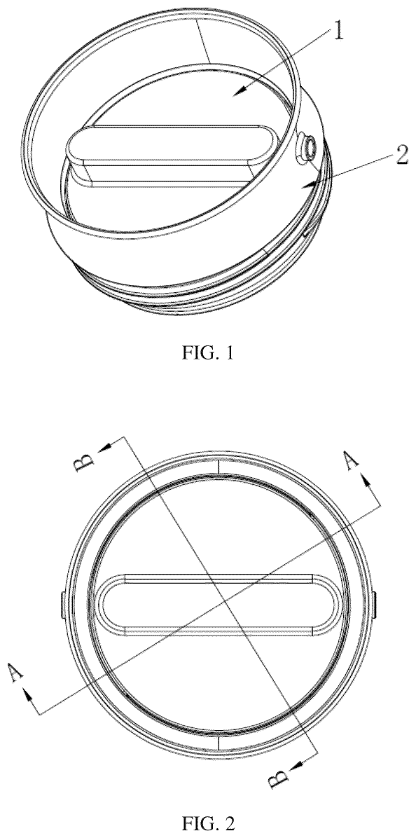

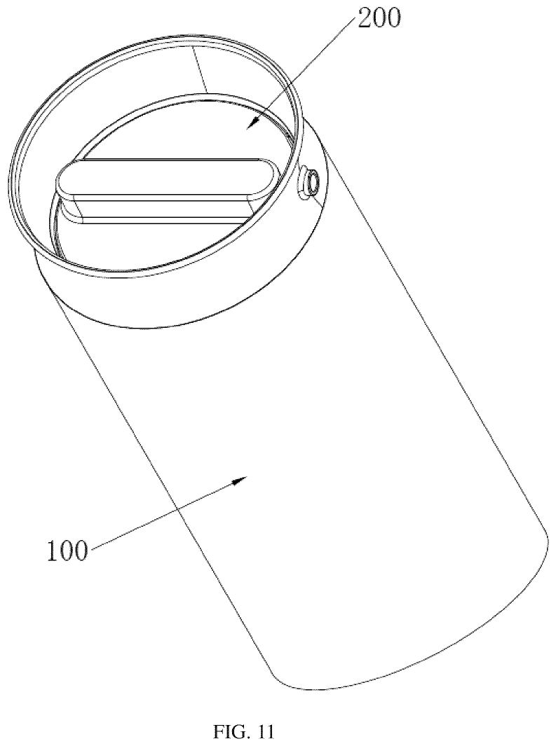

Referring to FIG. 1 to FIG. 10, the invention discloses a cap, including a body 2 and a rotary plug element 1. The body 2 includes a coupling portion 21 and a discharge portion 22 annularly arranged at one end of the coupling portion 21. The coupling portion 21 is provided with an external thread configured to be coupled to an open container. The rotary plug element 1 is arranged in the body 2 and forms a threaded coupling with the body 2. The rotary plug element 1 is selectively located in a first position P₁ or a second position P₂ of the body 2 through the threaded coupling. When the rotary plug element 1 is located in the first position P₁ of the body 2, a ring-shaped channel T is formed between the rotary plug element 1 and the body 2, so that contents of the container can be poured out through the channel T. When the rotary plug element 1 is located in the second position P₂ of the body 2, the rotary plug element 1 forms a sealed coupling with the body 2, thereby preventing the contents of the container from leaking out through between the body 2 and the rotary plug element 1. The first position P₁ of the body 2 relative to the second position P₂ is defined as an open direction X1 and an opposite as a closed direction X2. The discharge portion 22 of the body 2 is located in the open direction X1 of the coupling portion 21. In this embodiment, an axial direction of the rotary plug element 1, an axial direction of the body 2, the open direction X1 and the closed direction X2 are parallel. The ring shape of the channel T means that the channel T extends along the ring direction when viewed from the top of the cap.

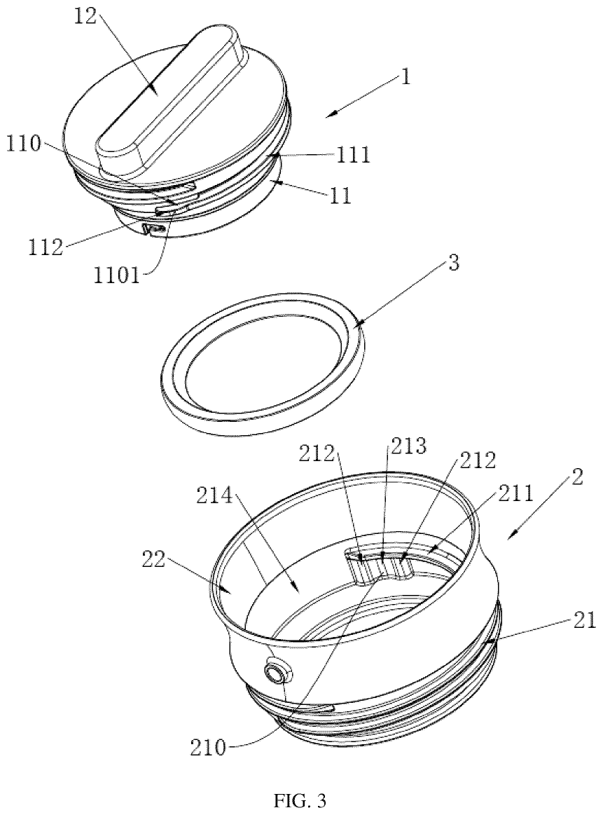

Referring to FIG. 3 to FIG. 5, the rotary plug element 1 includes a rotary plug portion 11 provided with first threaded protrusions 111. An end portion of the first threaded protrusion 111 is provided with a cantilever structure 110, and a free end of the cantilever structure 110 forms a first snap fit structure 1101 extending along the radial direction of the rotary plug portion 11. An inner side of the coupling portion 21 of the body 2 is provided with second threaded protrusions 211 and second snap fit structures 210. The first threaded protrusions 111 and the second threaded protrusion 211 are fitted to form the threaded coupling between the rotary plug element 1 and the body 2. The first snap fit structures 1101 and the second snap fit structures 210 are fitted to limit the rotary plug element 1 to the first position P₁ or the second position P₂ of the body 2. The second snap fit structure 210 is located in the closed direction of the second threaded protrusion 211. When the rotary plug element 1 is located in the first position P₁ relative to the body 2, the second threaded protrusion 211 can function to stop the first snap fit structure 1101, thereby preventing the rotary plug element 1 from coming out of the body 2.

Referring to FIG. 3 to FIG. 5, a surface of the cantilever structure 110 away from a central axis of the rotary plug portion 11 is provided with a first protruding portion 112 protruding along the radial direction of the rotary plug portion 11, and the first protruding portion 112 forms the first snap fit structure 1101. An inner side surface of the coupling portion 21 of the body 2 is provided with a plurality of second protruding portions 212 protruding along the radial direction of the body 2. A groove 213 is formed between two of the second protruding portions 212 spaced apart, and the groove 213 is matched with the first protruding portion 112, such that the two second protruding portions 212 spaced apart and the groove 213 therebetween form the second snap fit structure 210. The cantilever structure 110 has certain elasticity. When the rotary plug element 1 is rotated such that the first protruding portion 112 contacts one of the second protruding portions 212, under the action of the elasticity of the cantilever structure 110, the free end of the cantilever structure 110 is deformed away from the second protruding portion 212. The rotary plug element 1 is further rotated, such that the first protruding portion 112 smoothly goes across the second protruding portion 212 and is inserted into the groove 213 between the two second protruding portions 212, thereby realizing the snap fit between the first snap fit structure 1101 and the second snap fit structure 210. When the first protruding portion 112 smoothly goes across the second protruding portion 212 and is inserted into the groove 213, feedback is given to the user, thereby reminding the user that the rotary plug element 1 has been rotated into position. At this time, the rotary plug element 1 is located in the first position P₁ or the second position P₂ of the body 2.

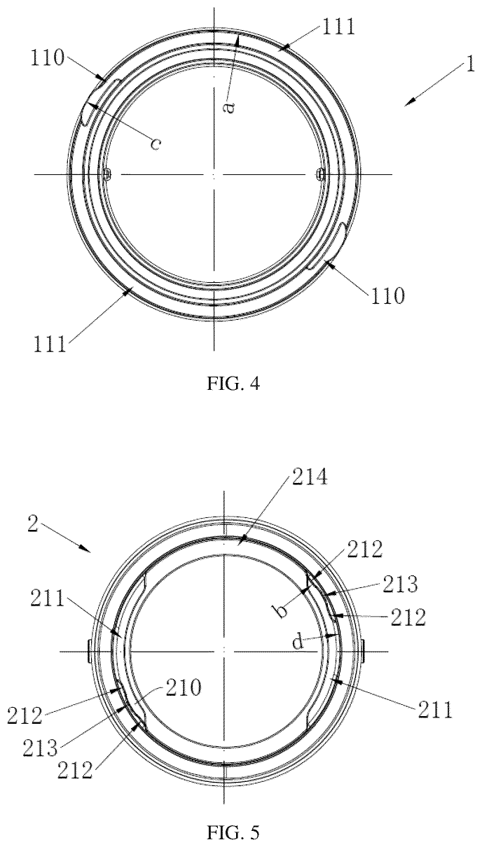

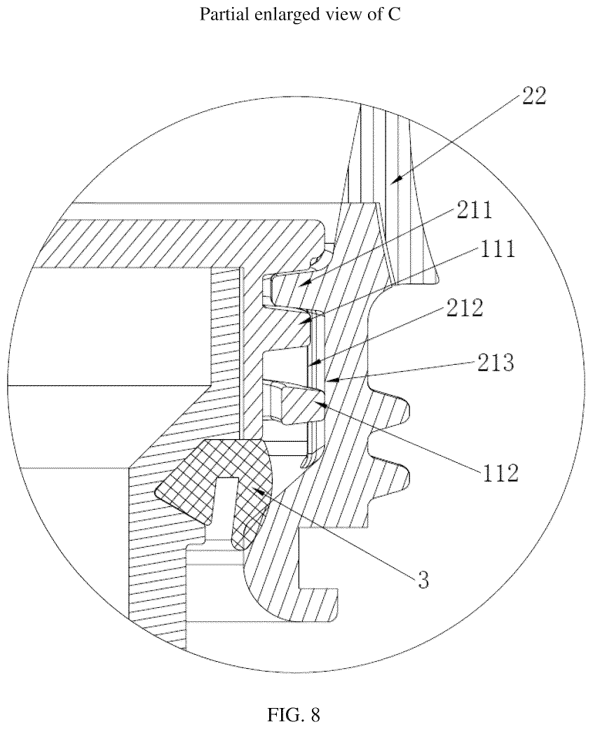

Referring to FIG. 4, FIG. 5 and FIG. 8, in order to allow the rotary plug element 1 to rotate smoothly when moving relative to the body 2, a radius a of the first threaded protrusion 111 should be less than or equal to a radius b of the body 2 at the second protruding portions 212, i.e., a≤b as shown in FIG. 7, and a radius c of the first protruding portion 112 should be less than or equal to a radius d of a bottom of the second threaded protrusion 211, i.e., c≤d. Additionally, in order to enable the first protruding portion 112 to be fitted with the groove 213 between the two second protruding portions 212, the radius c of the first protruding portion 112 should be greater than the radius b of the body 2 at the second protruding portions 212, i.e., c>b as shown in FIG. 7. Additionally, the second protruding portions 212 and the second threaded protrusion 211 all protrude from an inner wall of the coupling portion 21 of the body 2, and the radius d of the bottom of the second threaded protrusion 211 is the radius of the coupling portion 21 of the body 2, so b<d. In order to enable the first threaded protrusion 111 and the second threaded protrusion 211 to form a reliable threaded fit, the radius a of the first threaded protrusion 111 should be less than the radius d of the bottom of the second threaded protrusion 211, i.e., a<d. Based on the above, a≤b<c≤d.

In addition, the second protruding portion 212 should have a certain length in the axial direction of the body 2, and the length is not less than an axial distance that the rotary plug element 1 moves from the first position P₁ to the second position P₂. In this way, no matter whether the rotary plug element 1 is located in the first position P₁ or the second position P₂, the first snap fit structure 1101 and the second snap fit structure 210 can form the snap fit.

In this embodiment, by forming the first snap fit structure 1101 through the cantilever structure arranged at the end portion of the first threaded protrusion 111, when the first snap fit structure 1101 and the second snap fit structure 210 form the snap fit, it means that the rotary plug element 1 reaches the first position P₁ or the second position P₂, thereby reminding the user to stop rotating the rotary plug element 1. The first protruding portion 112 goes across one of the second protruding portion 212 with the aid of the elasticity of the cantilever structure so as to be fitted with the groove 213, and is stuck by the two second protruding portions 212 to form the snap fit between the first snap fit structure 1101 and the second snap fit structure 210, thereby preventing the rotary plug element 1 from continuing rotating.

In another embodiment, the first snap fit structure 1101 may be arranged in a middle of the first threaded protrusion 111, and the position of the second snap fit structure 210 on the inner side of the body 2 is moved accordingly, so as to change its position relative to the second threaded protrusion 211. In this case, when the rotary plug element 1 is in the first position P₁, the channel T formed between the rotary plug element 1 and the body 2 has a small cross-sectional area, which is suitable for the situation where a liquid is contained in the container and a small flow rate is required when the liquid is poured. Alternatively, in order to ensure a sufficient cross-sectional area of the channel T formed between the rotary plug element 1 and the body 2 when the rotary plug element 1 is in the first position P₁, lengths of the first threaded protrusion 111 and the second threaded protrusion 211 may be increased.

In the case where the first snap fit structure 1101 is arranged in the middle of the first threaded protrusion 111, the first snap fit structure 1101 may be an arc-shaped slingshot structure formed in the middle of the first threaded protrusion 111 so as to ensure the elasticity of the first snap fit structure 1101, thereby ensuring the smooth snap fit between the first snap fit structure 1101 and the second snap fit structure 210. Both the cantilever structure arranged at the end portion of the first threaded protrusion 111 and the arc-shaped slingshot structure arranged in the middle of the first threaded protrusion 111 are a part of the first threaded protrusion 111, so the first snap fit structure 1101 is also a part of the first threaded protrusion 111.

The first snap fit structure 1101 may be formed not only by the cantilever structure or the slingshot structure described above, but also by an elastic element fixedly arranged at the first threaded protrusion, and the elastic element is arranged on a surface of the first threaded protrusion 111 away from the central axis of the rotary plug portion 11. The elastic element may be made of a highly elastic material such as silicone or rubber. The first threaded protrusion 111 is a plastic element or a metal element integrally formed on the rotary plug element 1 and has low elasticity, and the cantilever structure or the slingshot structure changes its elasticity by changing the structure, thereby ensuring that the first protruding portion 112 can smoothly go across the second protruding portion 212.

Referring to FIG. 4 to FIG. 6, a number of the first threaded protrusions 111 is two, and the two first threaded protrusions 111 are located in the same position along the axial direction of the rotary plug portion. Each of the first threaded protrusions 111 is provided with one of the first snap fit structures 1101, and the two first snap fit structures 1101 are oppositely arranged at two ends of any diameter of the rotary plug portion 11. A number of the second threaded protrusions 211 is also two, each of the second threaded protrusions 211 is correspondingly provided with one of the second snap fit structures 210 in the closed direction, and the two second snap fit structures 210 are oppositely arranged at two ends of any diameter of the body 2. In this way, the first threaded protrusions 111 and the second threaded protrusions 211 form two independent threaded couplings, so that the length of the first threaded protrusion 111 can be reduced, the distance of the rotary plug element 1 moving from the first position P₁ to the second position P₂ can be shortened, and the axial length of the rotary plug element 1 can be reduced, thereby reducing the height of the container having the cap. The height of the container of the invention refers to the distance between two ends of the container along the axial direction of the rotary plug element. When the cap is arranged at the top of the container, the distance between the upper and lower ends of the container is the height of the container of the invention. When the cap is arranged at a side of the container, the distance between the left and right ends or between the front and rear ends of the container is the height of the container of the invention.

In this embodiment, there are two first snap fit structures 1101 and two second snap fit structures 210 that are respectively located at two ends of any diameter of the corresponding part (the rotary plug element 1 or the body 2), so that as long as the rotary plug element 1 is rotated by 180°, the rotary plug element can move from the first position P₁ to the second position P₂ or from the second position P₂ to the first position P₁. In another embodiment, one first snap fit structure 1101 and two second snap fit structures 210 can also realize the switching of the rotary plug element 1 between the first position P₁ and the second position P₂ when rotated by 180°. However, in this case, the second snap fit structures 210 should be arranged at two ends of a diameter of the body 2, i.e., the second snap fit structures 210 are separated by 180°, and when the rotary plug element 1 is located in the first position P₁ or the second position P₂, the first snap fit structure 1101 is fitted with one of the two second snap fit structures 210. In another embodiment other than the two embodiments, the numbers of the first snap fit structures 1101 and the second snap fit structures 210 may also be one or more than two respectively. When the numbers of the first snap fit structures 1101 and the second snap fit structures 210 are one respectively, the rotary plug element I should be rotated by 360° to realize the two snap fits. When the numbers of the first snap fit structures 1101 and the second snap fit structures 210 are more than two respectively, the rotary plug element 1 can switch between the first position P₁ and the second position P₂ by being rotated by less than 180°. In this case, the channel T formed between the rotary plug element 1 and the body 2 has a small cross-sectional area, which is suitable for a container with a lower discharge velocity.

At the moment when the first snap fit structure 1101 snaps into the second snap fit structure 210 and the moment when the first snap fit structure snaps out of the second snap fit structure, tactile feedback can be provided to the user, thereby reminding the user that the rotary plug element has been rotated into position. An inner wall of the body 2 may also be provided with indications for open and closed states. For example, based on different heights of the rotary plug element 1 relative to the body 2 in the open and closed states, the inner wall of the body may be designed with different colors along the height direction, so that the user can see different colors on the inner wall of the body 2 when the cap is in the open and closed state, thereby providing visual feedback to the user. The indications for open and closed states and the two snap fit structures arranged on the inner wall of the body 2 provide tactile feedback and visual feedback to the user, so as to remind the user that the rotary plug element has been rotated into position, which makes the cap more convenient to use.

Referring to FIG. 3 and FIG. 5, the two second threaded protrusions 211 are spaced apart in the ring direction so as to form primary discharge openings 214 at the spacings. Since there is no block of the second threaded protrusion 211, the discharge of the primary discharge opening 214 is smoother. However, since the outer diameter a of the first threaded protrusion 111 should be less than the diameter d of the bottom of the second threaded protrusion 211, i.e., a<d, a channel T can also be formed between the outermost end of the first threaded protrusion 111 and the bottom end of the second threaded protrusion 211, but this channel T has a smaller cross-sectional area, which is suitable for the situation where the contents are liquid or fine particles. Thereby, a secondary discharge port is formed in a region where the second threaded protrusion 211 is provided. The secondary discharge port has a lower discharge flow rate or velocity. In this embodiment, two primary discharge openings 214 are formed. In another embodiment, a number of the primary discharge openings 214 may be reduced by extending the second threaded protrusion 211. In addition, extending the second threaded protrusion 211 can also reduce the size of the primary discharge opening 214, thereby controlling the discharge velocity.

Referring to FIG. 3, the body 2 includes the coupling portion 21 and the discharge portion 22. The discharge portion 22 is arranged at one end of the coupling portion 21, and the discharge portion 22 is located in the open direction of the coupling portion 21. In this embodiment, the discharge portion 22 is a ring-shaped structure annularly arranged at one end of the coupling portion 21 and having a circular ring-shaped cross section, and from the closed direction X2 to the open direction X1, an inner diameter of the discharge portion 22 gradually increases so as to form a flared structure. The discharge portion 22 having the flared structure functions to guide the poured contents of the container, thereby preventing the contents from scattering around. When the container is used as a cup, the discharge portion 22 can be used as a part for contacting a person's mouth, so that the user can drink conveniently. In another embodiment, the discharge portion 22 may also be a non-ring-shaped structure, for example, it only extends a section along the ring direction of the coupling portion 21. In addition, for more reasonable discharge, the position of the discharge portion 22 preferably corresponds to the primary discharge opening 214.

Referring to FIG. 3, in order to facilitate the operation of the rotary plug element 1, the rotary plug element 1 is further provided with a hand-held portion 12, and the hand-held portion 12 is located in the open direction of the rotary plug portion 11, so that the user can rotate the rotary plug element 1 by holding the hand-held portion 12, thereby moving the rotary plug element 1 relative to the body 2. In this embodiment, the hand-held portion 12 is a straight slat protruding from the rotary plug portion 11. In another embodiment, the hand-held portion 12 may be a protruding rod.

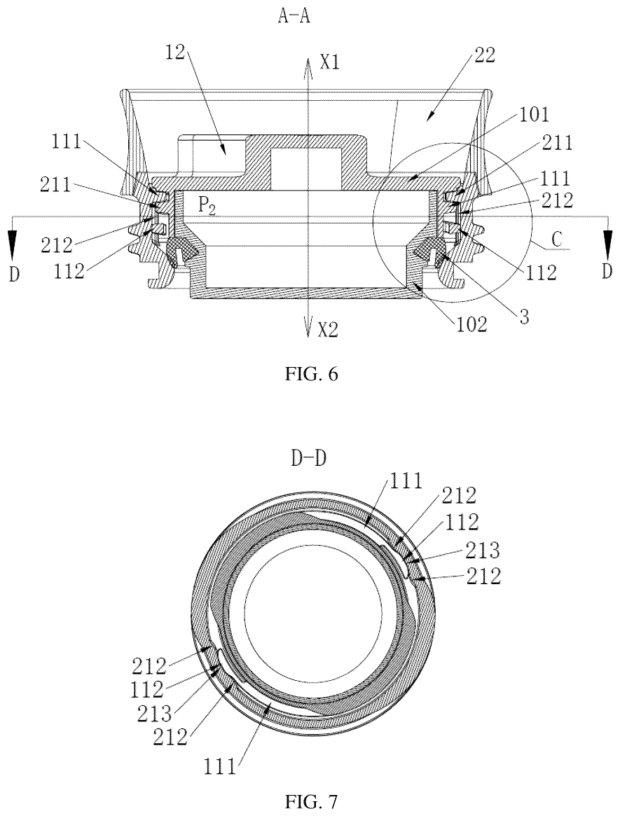

Referring to FIG. 3 and FIG. 6, a sealing element 3 is further arranged between the rotary plug element 1 and the body 2. The sealing element 3 is specifically sleeved outside the rotary plug portion 11 of the rotary plug element 1. When the rotary plug element 1 is located in the second position P₂ relative to the body 2, the sealing element 3 forms a sealed coupling with the body 2. The sealing element 3 is a silicone sealing ring or a rubber sealing ring.

In this embodiment, the rotary plug element 1 is formed by fixedly connecting a first part 101 and a second part 102. The first part 101 is provided with the hand-held portion 12 and the first threaded protrusions 111, and the second part 102 is coupled to the sealing element. The body 2 is also formed by two parts, namely the coupling portion 21 and the discharge portion 22, i.e., the coupling portion 21 and the discharge portion 22 are two independent parts that are fixedly connected to form the body 2.

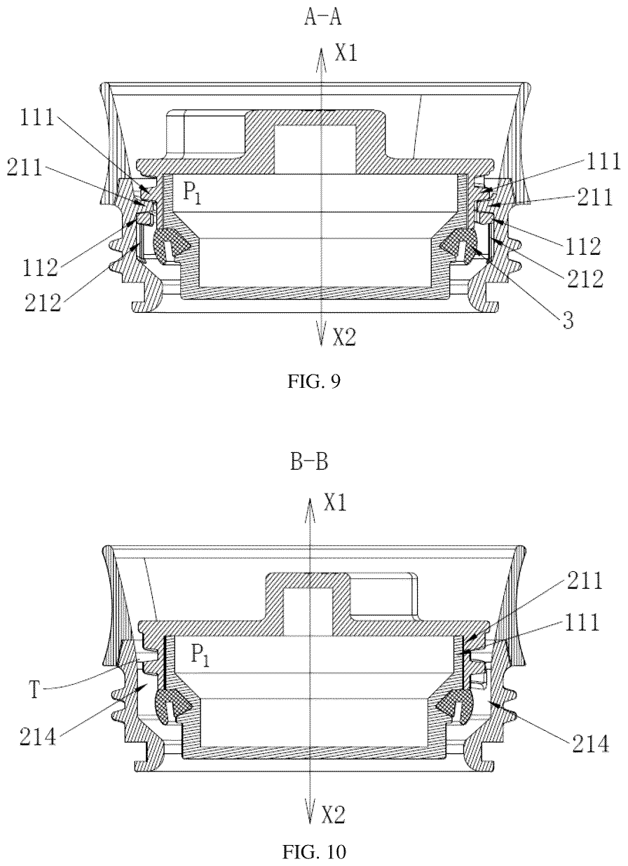

Referring to FIG. 6 and FIG. 7, the rotary plug element 1 is located in the second position P₂ relative to the body 2, and the body 2 is fixed. When the operator rotates the rotary plug element 1 through the hand-held portion 12 to make the rotary plug element 1 rotated by 180°, the rotary plug element 1 moves along the open direction X1 from the second position P₂ shown in FIG. 6 to the first position P₁ shown in FIG. 9. Thereby, a channel T is formed between the rotary plug element 1 and the body 2, and the contents of the container can be discharged through the channel T. When the operator rotates the rotary plug element 1 reversely to make the rotary plug element 1 rotated reversely by 180°, the rotary plug element 1 moves along the closed direction X2 from the first position P₁ shown in FIG. 9 to the second position P₂ shown in FIG. 6, so that the rotary plug element 1 forms a sealed coupling with the body 2.

### Embodiment 2

Referring to FIG. 11, the invention further discloses a container. The container is a cup, including an open container 100 and a cap 200. A body 2 of the cap 200 is coupled to the open container 100 so as to couple the cap 200 to the open container 100. In this embodiment, a coupling portion 21 of the body 2 is provided with an external thread such that the cap 200 forms a threaded coupling with the open container 100. In another embodiment, the cap 200 and the open container 100 may also form a detachable coupling such as a snap fit.

When a rotary plug element 1 of the cap 200 is located in a second position P₂ shown in FIG. 6 relative to the body 2, water in the cup can flow out through a channel T between the rotary plug element 1 and the body 2. When the rotary plug element 1 of the cap 200 is located in a first position P₁ shown in FIG. 9 relative to the body 2, the cup is tightly closed, and the water in the cup does not flow out.

The container of the invention refers to a basic device for containing materials, which mainly includes a shell and is provided with a cap. In addition to the cup of this embodiment, the container of the invention may also be another container with a cap, such as a cylinder, a canister, a box or a case. The contents may be water, and other fluids or solids.

Although the invention has been specifically shown and described in conjunction with the preferred implementations, it should be understood by those skilled in the art that the remaining unexplained parts are the prior art and that various changes made thereto in forms and details without departing from the spirit and scope of the invention as defined in the appended claims shall fall within the scope of protection of the invention.

1. A cap, comprising a body and a rotary plug element, the rotary plug element being arranged in the body and forming a threaded coupling with the body, the rotary plug element being selectively located in a first position or a second position of the body through the threaded coupling, when the rotary plug element is located in the first position of the body, a ring-shaped channel is formed between the rotary plug element and the body, when the rotary plug element is located in the second position of the body, the rotary plug element forms a sealed coupling with the body, and a direction from the first position of the body to the second position being defined as an opening direction and a direction from the second position of the body to the first position being defined as a closing direction, wherein
the rotary plug element comprises a rotary plug portion provided with first threaded protrusions, the first threaded protrusions are each provided with a first snap fit structure protruding along a radial direction of the rotary plug portion, the body is provided with second threaded protrusions and second snap fit structures that extend along a radial direction of the body, the second snap fit structures are located on a side of the body facing the closing direction, the second threaded protrusions are located on a side of the body facing the opening direction, and when the rotary plug element is located in the first position or the second position of the body, the first snap fit structure and the second snap fit structures form a snap fit.

2. The cap according to claim 1, wherein an end portion of each of the first threaded protrusions is provided with a cantilever structure, and the first snap fit structure is arranged at a free end of the cantilever structure.

3. The cap according to claim 1, wherein a surface of each of the first threaded protrusions away from a central axis of the rotary plug portion is provided with a first protruding portion protruding along the radial direction of the rotary plug portion, the first protruding portion forms the first snap fit structure, an inner side surface of the body is provided with a plurality of second protruding portions protruding along the radial direction of the body, a groove is formed between two of the plurality of second protruding portions that are spaced apart, and the groove is matched with the first protruding portion, such that the two of the plurality of second protruding portions that are spaced apart and the groove therebetween form the second snap fit structures; and
an outer diameter of each of the first threaded protrusions is less than or equal to an inner diameter of the body at the plurality of second protruding portions, such that during rotation of the rotary plug element, the first protruding portion is capable of going across one of the plurality of second protruding portions to be fitted with the groove.

4. The cap according to claim 1, wherein a number of the first threaded protrusions is two, each of the first threaded protrusions is provided with one of the first snap fit structures, and the two first snap fit structures are oppositely arranged at two ends of any diameter of the rotary plug portion.

5. The cap according to claim 1, wherein a number of the second threaded protrusions is two, each of the second threaded protrusions is correspondingly provided with one of the second snap fit structures in the closed direction, and the two second snap fit structures are oppositely arranged at two ends of any diameter of the body.

6. The cap according to claim 1, wherein the second threaded protrusions are spaced apart in a ring direction so as to form primary discharge openings at the spacings.

7. The cap according to claim 1, wherein the body comprises a coupling portion and a discharge portion, the second threaded protrusions and the second snap fit structures are arranged at the coupling portion, the discharge portion is arranged at one end of the coupling portion, and the discharge portion is located on a side of the body facing the opening direction.

8. The cap according to claim 7, wherein the discharge portion is a ring-shaped structure with a circular ring-shaped cross section, and from the closing direction to the opening direction, an inner diameter of the discharge portion gradually increases.

9. The cap according to claim 1, wherein the rotary plug element is provided with a hand-held portion, and the hand-held portion is located on a side of the body facing the opening direction.

10. A container, comprising an open container and the cap according to claim 1, wherein the body of the cap is coupled to the open container.

11. The container according to claim 10, wherein the container is a cup.
